(19) United States
(12) Patent Application Publication
(10) Pub. No.: US 2014/0005981 A1
(43) Pub. Date: Jan. 2, 2014

(54) METHOD FOR STATISTICAL QUALITY ASSURANCE IN AN EXAMINATION OF STEEL PRODUCTS WITHIN A STEEL CLASS

(71) Applicant: Hans-Ulrich Löffler, Erlangen (DE)

(72) Inventor: Hans-Ulrich Löffler, Erlangen (DE)

(21) Appl. No.: 13/928,442

(22) Filed: Jun. 27, 2013

(30) Foreign Application Priority Data
Jun. 28, 2012 (DE) 102012211184.0
Sep. 17, 2012 (DE) 102012216514.2

(51) Int. Cl. G06F 17/18

(52) U.S. Cl. CPC G06F 17/18
USPC 702/181

(57) ABSTRACT

A method for statistical quality assurance in an examination of steel products within a steel class is provided. Initially measurement samples are taken to determine at least one mechanical property. In addition to the measurement results, computed results of a computer-aided model for calculating the mechanical property of the respective steel product are used. Taking into account the statistical deviation between the measured results and the computed results, a statement is made as to whether the steel products have a specified probability of achieving a target value for the mechanical property.

### CROSS REFERENCE TO RELATED APPLICATIONS

The present application claims priority to German applications No. 10 2012 211184.0 DE filed Jun. 28, 2012 and No. 10 2012 216514.2 DE filed Sep. 17, 2012, the entire content of which is hereby incorporated herein by reference.

### FIELD OF INVENTION

The invention relates to a method for statistical quality assurance in an examination of steel products within a steel class.

### BACKGROUND OF INVENTION

For verifying the strength of steel strips or plates for example, destructive tensile samples are taken in accordance with DIN EN 10002-1. This means that measurement pieces of the product (usually at the strip ends) are cut off, the samples are prepared and torn apart in the tensile test. In such cases a so-called stress expansion curve is recorded.

Since taking the samples is expensive and time-consuming, only statistical samples are usually taken, e.g. only every tenth steel strip or plate is sampled.

The specification for samples is made by the quality office and depends on various aspects: Desire of the end customer for sampling, specification of pertinent standards EN 10204, non-specific testing for the works certificate “2.2” or specific testing by the acceptance test certificate “3.1.B”, statistical uncertainty of the process, etc.

As a rule the steel manufacturer divides his products into classes, so that he obtains a measure within the steel class via the samples taken for the spread of the mechanical properties such as e.g. the tensile strength, the tensile or compressive limit, the fracture strain.

For steel classes in which the process is very stable, i.e. the spread is small, it is sufficient to take a sample from time to time in order to ensure that the process has not changed. For steel classes with a large spread corresponding statistical certainty must be calculated in, so that the product fulfills the required properties at the desired significance level.

### SUMMARY OF INVENTION

The underlying object of the invention is to make possible an improvement in the statistical certainty of mechanical tensile samples.

In accordance with the invention the object is achieved by a method according to the claims. Further preferred embodiments and features of the invention emerge from the dependent claims.

Steel product is to be understood here as a steel strip or a steel plate. Mechanical properties are to be understood both as variables able to be measured physically in a tensile test such as tensile strength, the fracture strain, the tensile or compressive limit etc. and also structure properties (microstructure variables such as e.g. grain size, phase components such as ferrite, perlite, bainite or martensite) of the steel product, which influence the variables able to be measured in the tensile test indirectly or directly.

The invention is based on the idea of supplementing the measurement samples to determine a mechanical property of the steel products within a steel class, such as e.g. to determine the tensile strength, by calculated results which are calculated by means of a computer-aided model. In the comparison of the measurement results with the calculated results more precise information about the statistical probability with which the steel products of the selected steel class have achieved or fallen below a target value for the investigated mechanical property is obtained. The target value can also be a target range here.

The manufacturer usually defines a steel class with defined mechanical properties. Since the chemical composition and the process parameters are spread, the measured values of the samples taken are also spread, sometimes greatly. At this point the model helps to reduce the spread, in that with the model account can be taken of the differences in the form of different model input variables and thus more nuanced results obtained.

If the statistical deviation between measurement and calculation is better than the statistical deviation from the average value, then by the use of the computer-aided model as an estimator for the measured value the statistical certainty can be improved.

The method even goes one step further in that, on the basis of the comparison of the measurement results with the calculated results, information is preferably provided as to whether further measurement samples of individual steel products are required.

In accordance with a preferred embodiment variant the number of measurement samples to be taken within a steel class is determined as a function of the statistical deviation between the measurement results and the computed results. It is true to say here that more or additional measurement samples are taken when the measurement results and the computed results for the steel class investigated lie far apart. Also a large distribution alone leads to a high statistical uncertainty, in this case it is also advantageous to take further measurement samples.

In accordance with a further preferred embodiment variant the number of measurement samples to be taken is determined within a steel class as a function of the statistical deviation between the target value and the calculated results. This means that when the calculated results do not match the target value to a large extent, further measurement samples or measurement results are necessary in order to increase the statistical certainty.

A neural network, a linear regression or a combination of a neural network and a physical model are used as the model. In the physical model physical formulae are used with which from percentage alloy proportions (C, Mn, Si, etc.) and the process parameters (temperature, speed, time between process steps, degree of reshaping, reshaping speed, etc.) characteristic variables such as e.g. the tensile limit or the compressive strength can be calculated. Since these models have limited accuracy, neural networks are additionally used for example for correction.

In addition a reduction of the spread can be achieved in the measurement, by the model advantageously being used for cause analysis for the spread of the measurement results. With the aid of the model correlations between parameters or properties of the steel strips and large deviations of the measurement results from the target value and from one another can be determined easily and quickly.

### BRIEF DESCRIPTION OF THE DRAWINGS

An exemplary embodiment of the invention will be explained in greater detail with reference to a drawing, in which:

FIG. 1 shows a statistical spread of the measured values for the tensile strength within a steel class (measurement against computation),

FIG. 2 shows a distribution curve of the measurement results for the tensile strength in accordance with FIG. 1,

FIG. 3 shows an overlay of the distribution curves for the measurement results and the calculated results in accordance with FIG. 1.

The same reference characters have the same meaning in the different figures.

### DETAILED DESCRIPTION OF INVENTION

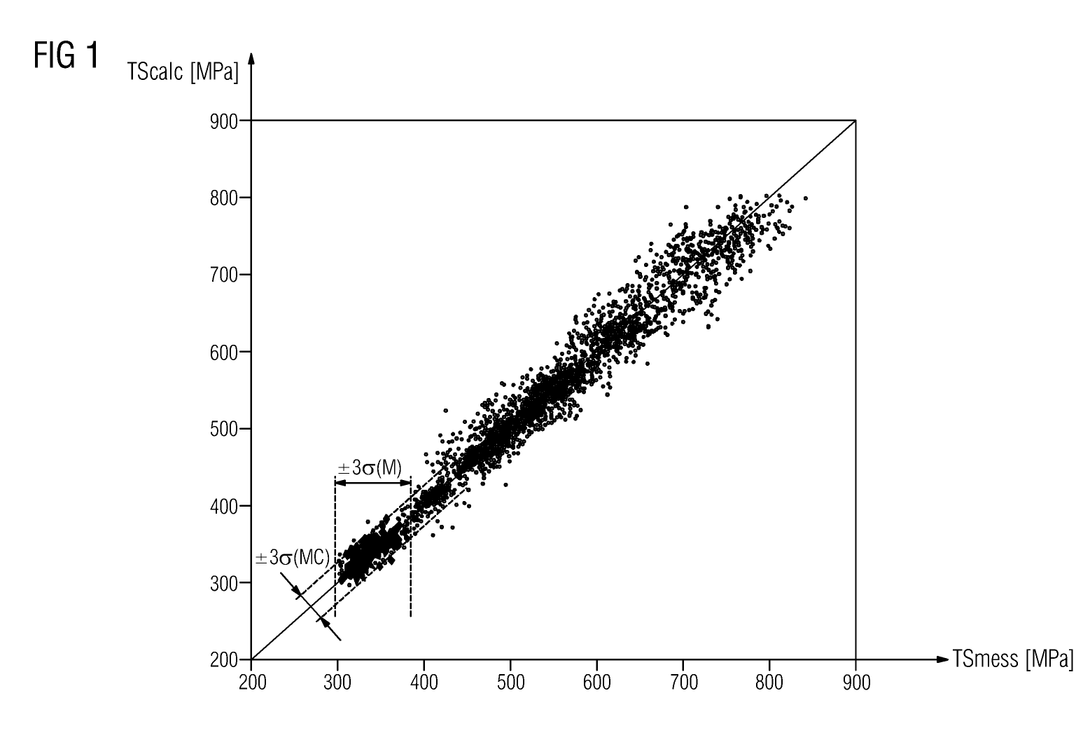

On the X and Y axis in FIG. 1 a measured or a calculated tensile strength TSₘₑₛₛ and TS_{calc} in [MPa] are plotted for the steel products of a steel class. TS stands for Tensile Strength. ±3σ(M) refers here to the spread of the measured values of the different samples. The spread of the deviation between the model calculation and measurement ±3σ(MC) is represented by dotted lines.

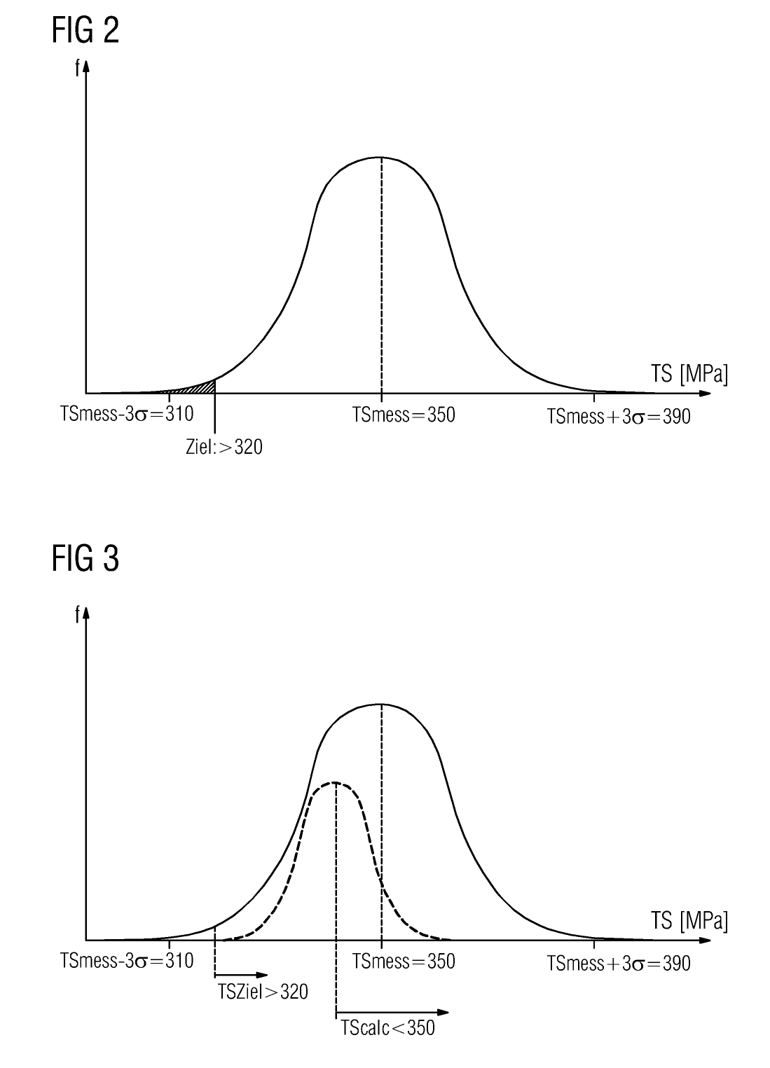

In FIG. 2 and FIG. 3 the tensile strength TS is plotted on the X axis and a frequency f with which a value for the tensile strength occurs is plotted on the Y axis. TS_{ziel} designates a target value, especially a required minimal tensile strength TS, which the steel products of the investigated steel class must exhibit.

The tolerance range ±3σ range was selected since, with an assumed normal distribution, 99.73% of the measured values lie within a tolerance range of ±3σ around an average value (see FIG. 2).

The advantage of the inventive evaluation of the tensile samples with the aid of a model lies in the fact that the span ±3σ(MC) of the deviation between model and measurement is smaller than the spread ±3σ(M) of the measurement itself (see FIG. 3), since the model can also take account of the natural spread of input parameters.

In the exemplary embodiment in FIG. 2 the span is ±3σ(M) ±40 MPa, the average value TSₘₑₛₛ for the measured tensile strength lies at around 350 MPa and the distribution is normally distributed, i.e. 99.73% of the samples lie within the interval 350−40 MPa and 350+40 MPa. In order now for example to be able to keep to a target value TS_{ziel} of at least 320 MPa with (99.73+0.27/2)% statistical certainty, a delivery of any given steel product of the examined steel class would not be sufficient, since the probability of obtaining a value for the tensile strength TS<320 MPa (within the cross-hatched area) is greater than (0.27/2)%.

Assuming that the deviation between model and measurement ±3σ(MC) is equal to ±20 M Pa and the distribution is normally distributed, then 99.73% of the samples lie within the interval TS_{calc}−20 MPa and TS_{calc}+20 MPa. This situation is shown in FIG. 3. In this case TS_{calc} is the value for the tensile strength calculated by the model.

This would enable those steel products of the steel class for which the calculated value is greater than 320+20=340 MPa to be delivered with 99.73% statistical certainty. In the exemplary embodiment in accordance with FIG. 3 all steel products can thus be delivered.

Especially advantageous is the fact that the calculated value TS_{calc} is available immediately after the production, while a measured value is only available after a few days (waiting to cool down, cutting sample, preparing sample, tearing apart sample, transferring evaluation). Steel products with TS_{calc}≧340 MPa can thus be delivered immediately, steel products with TS_{calc}<340 MPa can be kept for sampling and they are delivered when the value is TSₘₑₛₛ≧340 MPa, which with normal distribution has a more than 95% probability of being the case.

Because a sample is usually only taken at the strip ends, the sample is under some circumstances even less able to provide information than the computation, which can occur over the length of the strip: if for example information is only provided if all calculated values are TS_{calc}≧340 MPa, that is a better measurement of quality than if only one edge sample taken meets the requirements.

In summary the statistical certainty can be increased by a better estimator. If a steel class is merely evaluated by taking samples in a tensile test (without recording the associated input parameters), then it is merely known which spread the product has. A deduction to sensitivities is not known, which makes the analysis for reduction of the spread difficult. If a computer-aided model is set up so that the statistical accuracy of the model is the same or even better than the average value, then the computational sensitivity of the model can preferably be used for cause analysis and thus for reduction of the spread.

We claim:

1-8. (canceled)

9. A method for statistical quality assurance in an examination of steel products within a steel class, comprising:
taking measurement samples to determine at least one mechanical property of the respective steel product;
computing results using a computer-aided model for calculating the mechanical property of the respective steel product; and
determining a statistical deviation between the measurement results and the computed results,
wherein, taking into account the statistical deviation between the measured results and the computed results, a statement is made as to whether the steel products have a specified probability of achieving a target value for the mechanical property.

10. The method as claimed in claim 1,
wherein, on the basis of a comparison of the measurement results with the computed results, a statement is made as to whether further measurement samples of individual steel products are necessary.

11. The method as claimed in claim 9,
wherein a number of the measurement samples to be taken within the steel class is determined as a function of the statistical deviation between the measurement results and the computed results.

12. The method as claimed in claim 9,
wherein a number of measurement samples to be taken within a steel class is determined as a function of the statistical deviation between a target value for tensile strength and the computed results.

13. The method as claimed in claim 9,
wherein a neural network is used as the model.

14. The method as claimed in claim 9,
wherein a linear regression is used as the model.

15. The method as claimed in claim 9,
wherein a combination of a neural network and physical model is used as the model.

16. The method as claimed in claim 9,
wherein the model is used for cause analysis for the spread of the measurement results.
